(19) United States
(12) Patent Application Publication
(10) Pub. No.: US 2005/0058462 A1
(43) Pub. Date: Mar. 17, 2005

(54) Transmission format for supression of four-wave mixing in optical networks

(75) Inventors: Samad Talebpour, Richmond Hill (CA); Stephen W. Leonard, Unionville (CA)

Correspondence Address: Ralph A. Dowell of DOWELL & DOWELL P.C., 2111 Eisenhower Ave., Suite 406, Alexandria, VA, 22314, US

(73) Assignee: NOVX SYSTEMS, INC.

(21) Appl. No.: 10/660,799

(22) Filed: Sep. 12, 2003

(51) Int. Cl. H04B 10/04

(52) U.S. Cl. 398/199

(57) ABSTRACT

A method is provided for reducing crosstalk from four-wave mixing in optical networks. Return-to-zero optical pulses are stretched in time using a pulse stretcher and launched into a transmission fiber. The transmitted signal is recompressed using a pulse compressor prior to detection and electrical filtering. The resulting reduction in peak power of the transmitted pulses and the spectral broadening of the four-wave mixing products limits the crosstalk due to four-wave mixing and enhances the system performance.

### FIELD OF THE INVENTION

The invention relates to a method of reducing transmission impairments due to four-wave mixing in wavelength-division multiplexed optical networks, and more particularly the invention relates to the stretching and compressing of return-to-zero optical pulses so that the impairments due to the four-wave mixing are reduced.

### BACKGROUND OF THE INVENTION

Over the past decade, wavelength division multiplexing (WDM) systems have evolved to provide an enormous increase in the capacity of terrestrial and undersea telecommunications networks. As networks continue to grow, their capacity is often limited by phenomena including chromatic dispersion, polarization-mode dispersion, self-phase modulation, cross-phase modulation and four-wave mixing (FWM). In particular, when the channel spacing of a WDM system is narrowed to provide more optical channels, FWM is found to play an increasingly dominant role in limiting system performance.

FWM occurs due to the inherent nonlinearity of the refractive index of the glass core of optical fibers. This nonlinearity, manifested as a dependence of the refractive index on the optical intensity, produces deleterious effects when multiple channels co-propagate down the fiber. The nonlinear refractive index mediates an interaction between three channels (or two channels in the case of degenerate FWM), producing a fourth component with power at a new optical frequency. This new component (henceforth referred to as the FWM product) may be at the same frequency as another optical channel and cause severe degradation in the signal-to-noise ratio. For this reason, it is desirable to limit the crosstalk due to FWM so that the system performance is not hindered.

The power of the FWM products depends on many parameters including the optical power of the channels, the amount of chromatic dispersion, the channel spacing and the length over which the interaction occurs. One key factor that determines the power of FWM products is the degree of phase matching. Phase matching occurs when the difference between the propagation constants of all fields is zero, and leads to the efficient transfer of power from the channels to the FWM products. Typically the degree of phase matching increases dramatically when either the channel spacing or the chromatic dispersion is decreased to very low values.

Also of relevance is the number of mixing products. In a WDM system with N channels, the number of FWM products is given by

$$\frac{1}{2} ( {N}^{3} - {N}^{2} ) .$$

As an example, a 40-channel WDM system will produce 31200 FWM products. However, it is only the small groups of nearly phase-matched channels (i.e. channels spanning a narrow spectral range) that will produce FWM products with significant power. For this reason, FWM can strongly affect capacity upgrades that involve a decrease of the channel spacing, but has usually minimal effect on upgrades that simply add more channels to one or both sides of the existing WDM channel plan.

Most of the installed single-mode optical fiber base has a relatively large amount of chromatic dispersion that prohibits phase matching, resulting in inefficient FWM generation. Such systems generally only suffer from significant FWM when the channel spacing is decreased towards 25 GHz, at which point FWM becomes a dominant effect and limits the system reach.

However, prior to the realization that chromatic dispersion was beneficial in reducing FWM in WDM systems, a great deal of so-called “dispersion-shifted” fiber (also known by the International Telecommunication Union (ITU) specification G.653) was installed in specific regions of the world. This type of fiber was designed to have its zero-dispersion wavelength lie within the C-band near the minimum attenuation wavelength, which is ideal for optimizing the reach of single-channel systems that are limited by attenuation and dispersion. Unfortunately, placing the zero-dispersion wavelength in the operating band of WDM channels causes a group of channels to be almost perfectly phase matched, resulting in efficient FWM generation. Furthermore, the ITU requirement that channels reside on a uniform frequency grid compounds the problem since FWM products are then generated spectrally coincident with the optical channels. Therefore, dispersion-shifted fiber has been deemed ill suited for high channel-count WDM transmission.

A number of schemes designed to circumvent this problem have been suggested in the academic and patent literature. These approaches can be grouped into six general classes: modified channel spacing, incoherent interference, coherent destructive interference, polarization multiplexing, active out-of-band filtering and launch power reduction.

The first class uses an unequal spacing of the optical channels to ensure that the dominant FWM products do not lie at the same frequency as the data channels. This method has been discussed in detail in the literature (see, for example, F. Forghieri, “WDM Systems with Unequally Spaced Channels,” J. Light. Tech. 13, 889 (1995)) and many novel solutions have been proposed. Of these, the practical solutions that conform to the ITU specification of an equally spaced channel grid typically involve leaving many channel slots vacant (H. Myiata, U.S. Pat. No. 6,366,376). Such solutions have the disadvantage of poor spectral efficiency since much of the spectrum is underutilized. Another useful solution allows all channel slots to be occupied, but requires that the wavelengths of the optical transmitters be detuned such that FWM products do not fall within the receiver bandwidth (A. Boskovic et al., U.S. Pat. No. 6,118,563). Unfortunately, this approach is undesirable in that it requires precise locking of the transmitter wavelengths and large detunings relative to the pass bandwidth (e.g. ±20 GHz for Δf=100 GHz spacing).

The second class of solutions employs incoherent interference to reduce the power of FWM products in a multi-span system. This type of solutions typically uses optical delay lines at a mid-span point to delay all channels beyond their coherence lengths (F. Meli, U.S. Pat. No. 5,677,786; K. Inoue, “Suppression Techniques for Fiber FWM . . . ,” J. Light. Tech. 11, 455 (1993)). For example, in a two-span system (with amplification at the mid-span point), this scheme causes the second set of FWM products to be incoherent relative to the FWM products from the first span, so that the net FWM results from the addition of individual powers rather than electric field amplitudes. Although this method can be useful in a multi-span system where many spans each contribute moderate FWM power, it fails to produce a dramatic reduction in the system penalty for low span-count systems with high FWM power. Furthermore, the solution is bulky and costly, since the coherence lengths of externally-modulated, continuous-wave (CW) lasers can be quite long (>10 m) and separate delay lines are needed for each channel.

Another class of solutions uses coherent destructive interference to eliminate FWM products in a multi-span system. One method of achieving this is mid-span spectral inversion via optical phase conjugation (S. Watanabe, “Cancellation of Four-Wave Mixing in a Single-Mode Fiber . . . ,” Opt. Lett. 19, 1308 (1994); S. Watanabe, U.S. Pat. No. 6,341,026). Although this method works in principle, it requires that the input conditions are duplicated at the mid-span point (following amplification), which can be very difficult to achieve in long spans due to environmental fluctuations in power and polarization.

Polarization multiplexing may also be employed to suppress FWM generation. Two schemes for polarization multiplexing have been reported in the literature. In one scheme (K. Inoue, “Fiber Four-Wave Mixing Suppression Using Two Incoherent Polarized Lights,” J. Light. Tech. 12, 2116 (1993)), each transmitter uses two orthogonally polarized lasers to transmit the signal. If the two polarizations are uncorrelated in phase, the FWM power is reduced by about 3 dB. Another scheme (K. Inoue, “Arrangement of Orthogonal Polarized Signals,” IEEE Photon. Tech. Lett. 3, 560 (1991); N. S. Bergano and C. R. Davidson, U.S. Pat. No. 6,134,033) requires that the input polarizations of optical channels be interleaved in such a manner than even numbered channels and odd numbered channels have orthogonal polarization states. This scheme can in theory produce a significant reduction in FWM power. However, polarization-mode-dispersion (PMD) in installed fibers actually provides a significant benefit due to polarization rotation, and the additional improvement from polarization interleaving is small. Furthermore, the technique is usually limited to single-span systems, since PMD causes a significant relative polarization rotation of adjacent channels over long fiber lengths, washing out launch-point orthogonality.

The fifth class of FWM suppression techniques involves actively modulating the optical channel so that the FWM products become spectrally broadened. A narrowband electrical filter prior to the receiver is used to filter a large proportion of the FWM power, improving the system performance. An example of such a scheme uses modulation of the transmitter optical frequency (K. Inoue, “Reduction of Fiber Four-Wave Mixing Influence Using Frequency Modulation . . . ,” IEEE Photon. Tech. Lett. 4, 1301 (1992)). In this work, the frequency was modulated by injecting AC current directly into a laser diode at a frequency above the clock rate. Unfortunately, this method also suffers from introducing amplitude modulation that corrupts the signal quality.

Finally, it should be noted that the most direct approach to reducing FWM in WDM systems is to reduce the launch power of the optical channels. In long fiber spans with optically preamplified receivers, the launch power typically needs to be several dBm in order to ensure that a sufficiently high optical signal-to-noise ratio (OSNR) is obtained at the receiver. Schemes that tolerate lower launch powers, such as Raman amplification and forward error correction can therefore be very effective in reducing the system penalty due to FWM. Unfortunately, these schemes can be costly and often do not provide sufficient OSNR margin over life in systems with severe FWM.

In summary, although many methods of FWM suppression have been proposed, all methods suffer from several drawbacks that limit their ability to enhance system capacity in an efficient and reliable manner. Accordingly, it would be advantageous to provide a solution that provides a practical, cost-effective method of FWM suppression that is insensitive to environmental considerations.

### SUMMARY OF THE INVENTION

It is the object of the present invention to provide a method of enhancing the performance of wavelength-division multiplexed optical networks that suffer from degradation due to four-wave mixing. In particular, it is the object of the present invention to provide a method of increasing the capacity of such systems in a simple and cost-effective manner and to implement such methods in optical communication networks.

To achieve these and other objects, the invention provides a method of (a) temporally and spatially stretching return-to-zero (RZ) optical pulses, (b) transmitting the stretched pulses through one or more spans of optical fiber, and (c) compressing and detecting the transmitted pulses. A pulse stretcher is used to broaden the pulses prior to their launch into the transmission fiber, which serves to lower the peak power of the optical pulses and thus reduce the power of FWM products that are generated. Furthermore, the stretching of the optical pulses provides a frequency chirp, which causes the generated FWM products to have a broadened spectrum. Prior to detection, the pulses are compressed using an optical compressor that restores their initial return-to-zero pulse profile, but does not recompress the generated FWM products due to their different chirp profile. Finally, the received pulses are electrically filtered using a low-pass filter that passes the signal but removes the majority of the FWM power, thus reducing the crosstalk from four-wave mixing.

The present invention provides a method of suppressing four-wave mixing in a wavelength-division multiplexed optical communication network, comprising the steps of:
a) generating optical signal pulses in at least two wavelength channels and modulating the optical signal pulses in each of the at least two wavelength channels for encoding information onto the optical signal pulses in each of the at least two wavelength channels;
b) multiplexing the modulated optical signal pulses in each of the at least two wavelength channels;
c) temporally chirping the multiplexed modulated optical signal pulses;
d) transmitting the temporally chirped multiplexed modulated optical signal pulses through an optical fiber to a receiver;
e) temporally de-chirping the temporally chirped multiplexed modulated optical signal pulses at the receiver optically coupled to the optical fiber for reconstructing the originally multiplexed modulated optical signal pulses;
f) demultiplexing the de-chirped multiplexed modulated optical signal pulses to reconstruct the modulated optical signal pulses in each of the at least two wavelength channels;
g) detecting and converting the reconstructed modulated optical signal pulses in each of the at least two wavelength channels to associated modulated electrical signal pulses; and
h) filtering the associated modulated electrical signal pulses to remove out-of-band high frequency components due to four wave mixing of the multiplexed modulated optical signal pulses in each of the at least two wavelength channels.

In another aspect of the resent invention there is provided a method of suppressing four wave mixing in a wavelength-division multiplexed optical communication network, comprising the steps of:
a) generating optical signal pulses in at least two wavelength channels and modulating the optical signal pulses in each of the at least two wavelength channels for encoding information onto the optical signal pulses in each of the at least two wavelength channels;
b) temporally chirping the modulated optical signal pulses in each of the at least two wavelength channels;
c) multiplexing the temporally chirped modulated optical signal pulses in each of the at least two wavelength channels;
d) transmitting the multiplexed temporally chirped modulated optical signal pulses through an optical fiber to a receiver;
e) demultiplexing the multiplexed temporally chirped modulated optical signal pulses received at the receiver to reconstruct the temporally chirped modulated optical signal pulses in each of the at least two wavelength channels;
f) temporally de-chirping the temporally chirped modulated optical signal pulses in each of the at least two wavelength channels to reconstruct the modulated optical signal pulses in each of the at least two wavelength channels;
g) detecting and converting the reconstructed modulated optical signal pulses in each of the at least two wavelength channels to associated modulated electrical signal pulses; and
h) filtering the associated modulated electrical signal pulses to remove out-of-band high frequency components due to four wave mixing of the multiplexed modulated optical signal pulses in each of the at least two wavelength channels.

In another aspect of the resent invention there is provided a method of suppressing four-wave mixing in a wavelength-division multiplexed optical communication network, comprising the steps of:
a) generating a set of odd wavelength channels and modulating optical signal pulses in each of the odd wavelength channels for encoding information onto the optical signal pulses in each of the odd wavelength channels;
b) generating set of even wavelength channels and modulating optical signal pulses in each of the even wavelength channels for encoding information onto the optical signal pulses in each of the even wavelength channels;
c) multiplexing the modulated optical signal pulses in the odd wavelength channels;
d) multiplexing the modulated optical signal pulses in the even wavelength channels;
e) temporally chirping the multiplexed modulated optical signal pulses in the odd wavelength channels;
f) temporally chirping the multiplexed modulated optical signal pulses in the even wavelength channels;
g) interleaving the temporally chirped multiplexed modulated optical signal pulses in each of the odd wavelength channels with the temporally chirped multiplexed modulated optical signal pulses in each of the even wavelength channels;
h) transmitting the interleaved, temporally chirped multiplexed modulated optical signal pulses in the odd and even wavelength channels through an optical fiber to a receiver;
i) de-interleaving the interleaved, temporally chirped multiplexed modulated optical signal pulses in the odd and even wavelength channels, temporally de-chirping the temporally chirped multiplexed modulated optical signal pulses in the odd wavelength channels thereby reconstructing the multiplexed modulated optical signal pulses in the set of odd wavelength channels, temporally de-chirping the temporally chirped multiplexed modulated optical signal pulses in the even set wavelength channels thereby reconstructing the multiplexed modulated optical signal pulses in the set of even wavelength channels;
j) demultiplexing the temporally de-chirped multiplexed modulated optical signal pulses in the set of odd wavelength channels thereby reconstructing the modulated optical signal pulses in each of the odd wavelength channels, demultiplexing the temporally de-chirped multiplexed modulated optical signal pulses in the set of even wavelength channels thereby reconstructing the modulated even wavelength optical signal pulses in each of the even wavelength channels;
g) detecting and converting the reconstructed modulated optical signal pulses in each of the odd and even set of wavelength channels respectively to associated modulated electrical signal pulses; and
h) filtering the modulated electrical signal pulses associated with each wavelength channel of the odd and even set of wavelength channels to remove out-of-band high frequency components due to four wave mixing of the multiplexed modulated optical signal pulses in the odd and even sets wavelength channels.

The present invention provides a wavelength-division multiplexed optical communication network comprising a) an optical signal transmitter that includes i) an optical signal source array having at least two optical signal sources, each optical signal source producing optical signal pulses in a wavelength channel associated therewith, each of the at least two optical signal sources being optically coupled to an associated optical signal modulator for modulating the optical signal pulses that are output from the optical signal source coupled thereto to encode information onto the optical signal pulses in each wavelength channels. The network includes a multiplexer, each optical signal modulator having an output being optically coupled to the multiplexer for multiplexing the modulated optical signal pulses in all the wavelength channels; iii) an optical signal pulse stretcher being optically coupled to an output of the multiplexer for temporally chirping the multiplexed modulated optical signal pulses; iv) an optical fiber having opposed ends being optically coupled at one of the opposed ends to an output of the optical signal pulse stretcher through which the temporally chirped multiplexed modulated optical signal pulses are transmitted. The network includes an optical signal receiver optically coupled to the optical fiber for receiving the temporally chirped multiplexed modulated optical signal pulses, the optical signal receiver including, i) an optical signal pulse compressor having an input optically coupled to the other of the opposed ends of the optical fiber for temporally de-chirping the temporally chirped multiplexed modulated optical signal pulses for reconstructing the multiplexed modulated optical signal pulses, ii) a demultiplexer having an input optically coupled to an output of the optical signal pulse compressor for demultiplexing the reconstructed multiplexed modulated optical signal pulses to reconstruct the modulated optical signal pulses in each of the the wavelength channels, iii) an array of optical detectors, each of the optical detectors being connected to an associated output of the demultiplexer for converting the reconstructed modulated optical signal pulses in each wavelength channel to modulated electrical signal pulses, each optical detector including a filter electrically connected thereto for filtering the modulated electrical signal pulses with each filter having a predefined filter bandwidth for removing out-of-band frequency components due to four wave mixing arising from multiplexing the modulated optical signal pulses in the wavelength channels.

In accordance with this embodiment of the invention in which the pulse stretcher is placed after the multiplexer and the pulse compressor is placed prior to the demultiplexer, both the stretcher and compressor operate on a plurality of RZ channels spaced on a fixed frequency grid. The stretcher and compressor exhibit equal magnitudes of chromatic dispersion, but with the opposite sign.

In another aspect of the invention there is provided a wavelength-division multiplexed optical communication network, comprising:
a) an optical signal transmitter including,
i) an optical signal source array having at least two optical signal sources, each optical signal source producing optical signal pulses in a wavelength channel associated therewith, each of the at least two optical signal sources being optically coupled to an associated optical signal modulator for modulating the optical signal pulses that are output from the optical signal source coupled thereto to encode information onto the optical signal pulses in each of the wavelength channels,
ii) each optical signal modulator being optically coupled to an input of an associated optical signal pulse stretcher for temporally chirping the modulated optical signal pulses produced in the optical signal modulator coupled thereto,
iii) a multiplexer, each optical signal pulse stretcher including an output being optically coupled to the multiplexer for multiplexing the temporally chirped modulated optical signal pulses in all the respective wavelength channels;
iv) an optical fiber having opposed ends being optically coupled at one of the opposed ends to an output of the multiplexer through which the multiplexed temporally chirped modulated optical signal pulses are transmitted; and
b) an optical signal receiver optically coupled to the optical fiber for receiving the multiplexed temporally chirped modulated optical signal pulses, the optical signal receiver including,
i) a demultiplexer having an input being optically coupled to the other of the opposed ends of the optical fiber for demultiplexing the multiplexed temporally-chirped modulated optical signal pulses for reconstructing the temporally-chirped modulated optical signal pulses in each of the wavelength channels;
ii) an array of optical signal pulse compressors, each optical pulse compressor having an input optically coupled to an output of the demultiplexer for temporally de-chirping the demultiplexed temporally chirped modulated optical signal pulses to reconstruct the modulated optical signal pulses in each of the wavelength channels; and
iii) an array of optical detectors, each optical detector being optically coupled to an output of an associated optical signal pulse compressor for converting the reconstructed modulated optical signal pulses in each wavelength channel to modulated electrical signal pulses, each optical detector including a filter electrically connected thereto for filtering the modulated electrical signal pulses with each filter having a pre-defined filter bandwidth for removing out-of-band frequency components due to four wave mixing arising from multiplexing the modulated optical signal pulses in all the wavelength channels.

In accordance with this embodiment of the invention, a plurality of stretcher and compressor modules are arranged on a per-channel basis, prior to and following the multiplexer and demultiplexer, respectively.

In this aspect of the invention, the stretcher and compressor modules for each channel may provide unequal magnitudes of chromatic dispersion (but with the opposite sign) to further equalize pulse distortion caused by chromatic dispersion in the transmission fiber.

In this aspect of the invention, the optical signal pulse stretcher modules for adjacent channels have chromatic dispersion values with opposite signs in order to further broaden the spectrum of FWM products generated in the transmission fiber. In this embodiment, the stretcher and compressor modules for each channel have opposite signs of chromatic dispersion.

In accordance with another aspect of the invention, an additional dispersive element is placed at the mid-span location in a two-span system. This dispersive element reverses the sign of the chirp applied by the initial stretcher for each channel. The compressor and stretcher modules for each channel have equal signs of chromatic dispersion.

In another aspect of the present invention there is provided a wavelength-division multiplexed optical communication network, comprising:
a) an optical signal transmitter including,
i) an optical signal source array having
a first array of optical signal sources for producing optical signal pulses in at least two odd wavelength channels, each of the optical signal sources in the first array of optical signal sources being optically coupled to an associated optical signal modulator for modulating the optical signal pulses that are output from the optical signal source coupled thereto to encode information onto the optical signal pulses in each of the odd wavelength channels;
a second array of optical signal sources for producing optical signal pulses in at least two even wavelength channels, each of the optical signal sources in the second array of optical signal sources being optically coupled to an associated optical signal modulator for modulating the optical signal pulses that are output from the optical signal source coupled thereto to encode information onto the optical signal pulses in each of the even wavelength channels;
ii) a first multiplexer, each optical signal modulator connected to the optical signal sources in the first array of optical signal sources having an output which is optically coupled to the first multiplexer for multiplexing the modulated optical signal pulses in the odd wavelength channels, a second multiplexer, each optical signal modulator connected to the optical signal sources in the second array of optical signal sources having an output which optically coupled to the second multiplexer for multiplexing the modulated optical signal pulses in the even wavelength channels;
iii) a first optical signal pulse stretcher being optically coupled to an output of the first multiplexer for temporally chirping the multiplexed modulated optical signal pulses in the odd wavelength channels, a second optical signal pulse stretcher being optically coupled to an output of the second multiplexer for temporally chirping the multiplexed modulated optical signal pulses in the even wavelength channels, the second optical signal pulse stretcher applying a temporal chirp to the multiplexed modulated optical signal pulses in the even wavelength channels which is of opposite sign to a temporal chirp applied to the multiplexed modulated optical signal pulses in the odd wavelength channels by the first optical signal pulse stretcher;
iv) an optical signal pulse interleaver optically coupled to an output of each of the first and second multiplexors for interleaving the temporally chirped multiplexed modulated optical signal pulses in the odd wavelength channels with the temporally chirped multiplexed modulated optical signal pulses in the odd wavelength channels;
v) an optical fiber having opposed ends being optically coupled at one of the opposed ends to an output of the interleaver through which the interleaved, temporally chirped multiplexed modulated optical signal pulses from the odd and even wavelength channels are transmitted; and
b) an optical signal receiver for receiving the interleaved temporally chirped multiplexed modulated optical signal pulses from the odd and even wavelength channels, the optical signal receiver including,
i) an optical signal pulse de-interleaver being optically coupled to the other of the opposed ends of the optical fiber for de-interleaving the interleaved, temporally chirped multiplexed modulated optical signal pulses from the odd and even wavelength channels,
ii) a first optical signal pulse compressor being optically coupled to a first output of the de-interleaver for temporally de-chirping the multiplexed modulated optical signal pulses in the odd wavelength channels with a temporal chirp of opposite sign to the temporal chirp applied by the first optical signal pulse stretcher for reconstructing the multiplexed modulated optical signal pulses in the odd wavelength channels, a second optical signal pulse compressor being optically coupled to a second output of the de-interleaver for temporally de-chirping the multiplexed modulated optical signal pulses in the even wavelength channels with a temporal chirp of opposite sign to the temporal chirp applied by the second optical signal pulse stretcher for reconstructing the multiplexed modulated optical signal pulses in the even wavelength channels;
iii) a first demultiplexer having an input optically coupled to an output of the first optical signal pulse compressor for demultiplexing the reconstructed multiplexed modulated optical signal pulses in the odd wavelength channels to reconstruct the modulated optical signal pulses in each of the odd wavelength channels, a second demultiplexer having an input optically coupled to an output of the second optical signal pulse compressor for demultiplexing the reconstructed multiplexed modulated optical signal pulses in the even wavelength channels to reconstruct the modulated optical signal pulses in each of the even wavelength channels,
iv) a first array of first optical detectors, each of the first optical detectors being connected to an associated output of the first demultiplexer for converting the reconstructed modulated optical signal pulses in the odd wavelength channels to modulated electrical signal pulses, each of the first optical detectors having an associated filter electrically connected thereto for filtering the modulated electrical signal pulses produced therein with each filter having a predefined filter bandwidth for removing out-of-band frequency components due to four wave mixing arising from multiplexing the modulated optical signal pulses in the odd wavelength channels, a second array of second optical detectors, each of the second optical detectors being connected to an associated output of the second demultiplexer for converting the reconstructed modulated optical signal pulses in the even wavelength channels to modulated electrical signal pulses, each of the second optical detectors having an associated filter electrically connected thereto for filtering the modulated electrical signal pulses produced therein with each filter having a predefined filter bandwidth for removing out-of-band frequency components due to four wave mixing arising from multiplexing the modulated optical signal pulses in the even wavelength channels.

### BRIEF DESCRIPTION OF THE DRAWINGS

The invention will now be described, by way of non-limiting examples only, reference being made to the accompanying drawings, in which:

FIG. 1 illustrates a typical Prior Art WDM fiber-optic transmission system;

FIG. 2 is a plot of the bit-error ratio (BER) vs. launch power for the central channel of a 21-channel system for both RZ and NRZ formats;

FIG. 3 shows a modified WDM fiber-optic transmission system employing the present invention;

FIG. 4 shows an alternative embodiment of the present invention in which the stretchers and compressors are included with each transmitter and receiver;

FIG. 5 shows another alternative embodiment of the invention in which adjacent channels are chirped by stretchers and compressors with chirp values of alternating signs;

FIG. 6 shows another alternative embodiment of the invention in which even and odd channels are stretched and compressed separately in which adjacent channels are again chirped by stretchers and compressors with chirp values of alternating signs, yet using only two pairs of stretchers and compressors for all channels;

FIG. 7 shows a particular embodiment of a optical signal pulse stretcher or compressor in which the optical pulses are reflected off a chirped fiber Bragg grating;

FIG. 8 is a flowchart showing the optical signal shapes after passing through different components of the system of FIG. 3 illustrating the underlying principle of operation of the invention;

FIG. 9 compares the eye diagram for central channel of a 21-channel system for (a) RZ; (b) NRZ and (c) the inventive format; and

FIG. 10 is a plot of the bit-error ratio versus launch power for the central channel of a 21-channel system comparing RZ, NRZ and the present invention.

### DETAILED DESCRIPTION OF THE INVENTION

As discussed above, the present invention relates to fiber-optic transmission systems that employ temporal stretching and compression of optical signal pulses (preferably RZ pulses) to achieve a reduction in the penalty from four-wave mixing.

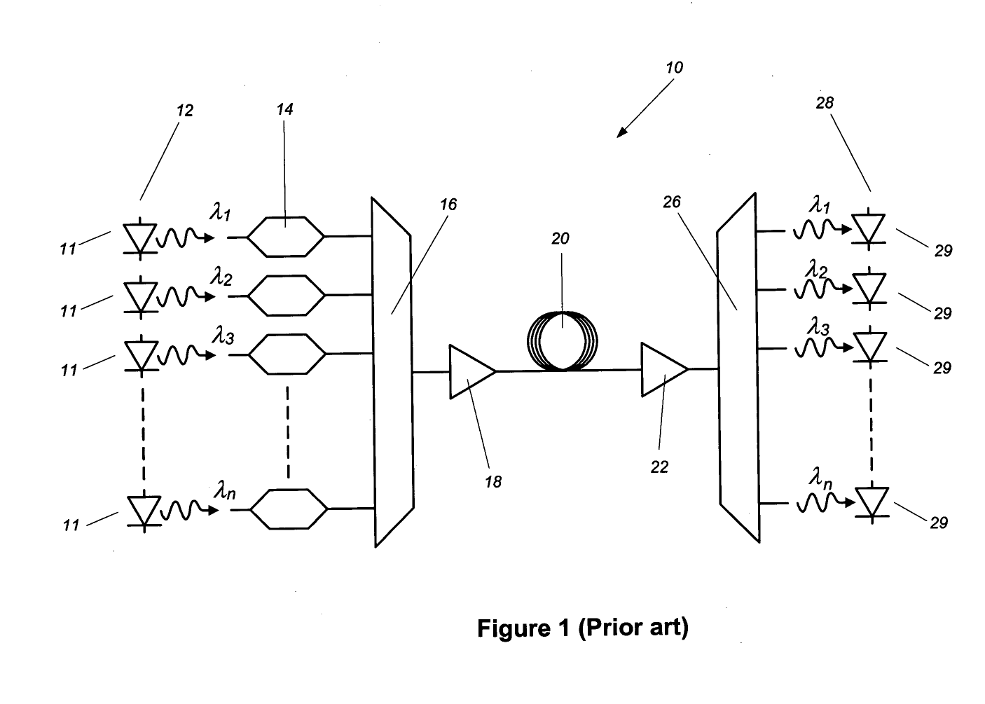

FIG. 1 shows a simplified schematic of a typical Prior Art WDM fiber-optic transmission system at 10. An optical signal source array 12 comprised of continuous-wave (CW) lasers 11 with wavelengths spaced on a fixed frequency grid are encoded with data by modulators 14 and multiplexed via a multiplexer 16. Each light source 11 produces light of a given wavelength (An) and a wavelength channel associated with each wavelength is input into an associated modulator 14 where data is encoded on the wavelength channel. The optical power of the multiplexed signal is boosted using a first erbium-doped fiber amplifier (EDFA) 18 and the signal is then launched into the transmission fiber 20. After propagating through the transmission fiber 20, the signal is preamplified by an EDFA 22 and individual channels are separated by the demultiplexer 26. The individual optical channels are then directly detected by the receiver array 28. The receiver array 28 converts the optical power to electrical current, which is then filtered by an electrical low-pass filter (not shown). The resulting electrical signal is then sent to a decision circuit (not shown) where it is digitally decoded. The transmission format is typically non-return-to-zero (NRZ), but may instead be return-to-zero (RZ). Although one span is shown, the transmission path may contain multiple spans with repeaters and/or regenerators. The transmission system may also include additional optical components including amplifiers, couplers, taps, etc., which are not shown in FIG. 1.

Depending on the configuration of the system, four-wave mixing may or may not play a dominant role in limiting the system performance. By way of example, a configuration is considered whereby four-wave mixing generates a prohibitively high system penalty. The example consists of a transmission link as shown in FIG. 1 with 21 transmitters with a channel spacing of Δf=100 GHz, considering both RZ and NRZ as the modulation formats. The launch power for all channels is the same. The system bit rate is 10 gigabits per second (Gbps). The optical fiber is chosen to be dispersion-shifted fiber with the following parameters: attenuation coefficient α=0.25 dB/km; effective area A_{eff}=53 μm²; chromatic dispersion D=0.2 ps/nm/km; chromatic dispersion slope dD/dλ=0 ps/nm²/km; nonlinear refractive index=2.8×10⁻²⁰ m²/W; and PMD coefficient=0.5 ps/(km)^{1/2}. The effective length of the fiber is given by L_{eff}˜1/α=17.9 km. The total length of the fiber is 120 km. The sensitivity of the receivers is taken to be −18 dBm for a bit-error ratio (BER) of 10⁻¹². The polarization states of all transmitters are aligned at the launch point and the individual transmitter clocks are synchronized to ensure complete pulse overlap among channels.

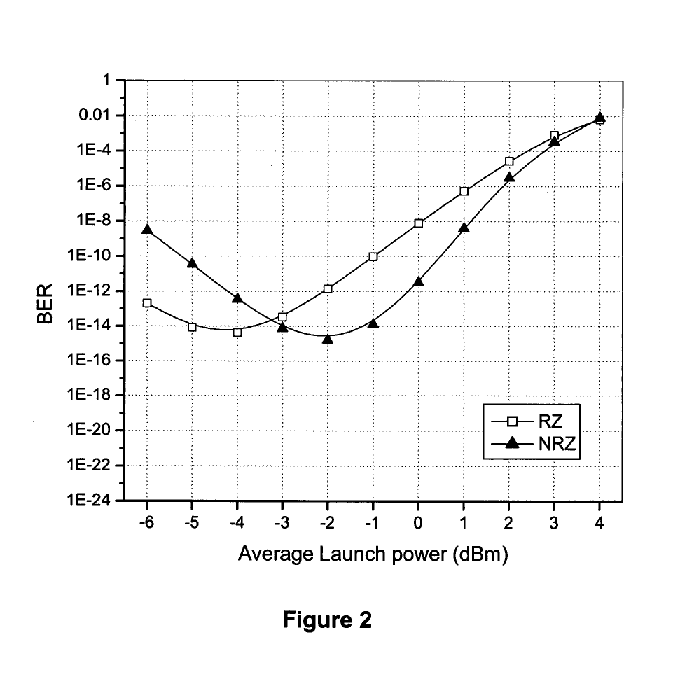

The results of a numerical simulation of the above system are shown in FIG. 2. The graph shows the dependence of the BER on the launch power of the central channel of the 21-channel system for a wide range of launch powers (for both RZ and NRZ formats). The simulation reveals that four-wave mixing critically limits the performance of the system and forces the BER above the commonly accepted criterion of BER<10⁻¹⁵. The performance degradation occurs as a result of four-wave mixing for high launch powers and OSNR degradation for low launch powers. This poor system performance can be dramatically improved using the said invention.

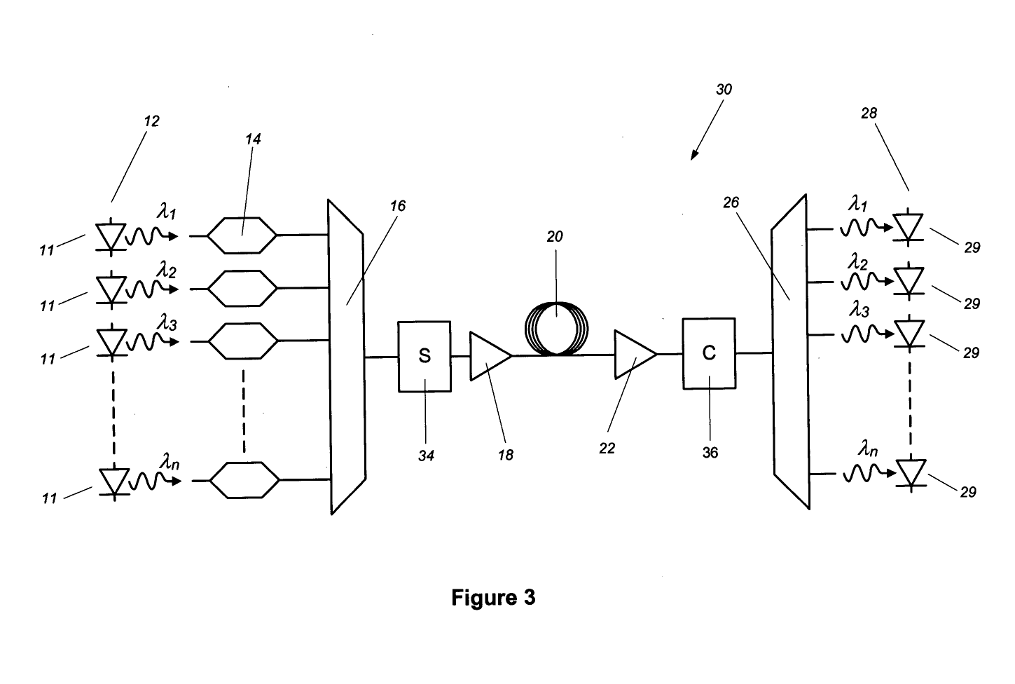

FIG. 3 illustrates how the representative wavelength-division multiplexed (WDM) optical communication network 10 of FIG. 1 is modified in accordance with the present invention to produce a WDM optical communication network system 30 for suppression of four-wave mixing in the optical network. The transmitter part of the network includes a parallel array of continuous-wave (CW) lasers 12 with wavelengths spaced on a fixed frequency grid are encoded with data by modulators 14 each being optically coupled to an associated optical signal source 12. The modulated optical signal pulses in each wavelength channel associated with each modulator 14 are then multiplexed via multiplexer 16. A pulse stretcher 34 is optically inserted immediately after the multiplexer 16 and before the amplifier 18 and is optically coupled to both. The pulse stretcher 34 operates on the modulated pulses by temporally chirping the pulses, thus stretching them in time and space. In a preferred embodiment of the invention, each modulator 14 generates RZ pulses. The optical power of the multiplexed signal is boosted using a first erbium-doped fiber amplifier (EDFA) 18 optically inserted into the network after the signal compressor 34 and the signal is then launched into the transmission fiber 20. After propagating through the transmission fiber 20, the signal is received in a receiver portion of the network in which the signal is first pre-amplified by an EDFA 22 and individual channels are separated by the demultiplexer 26. It will be appreciated by those skilled in the art that while the optical transmission medium is preferably an optical fiber 20, the present invention is not restricted to optical fibers and in fact free space could be the optical transmission medium in certain optical communication systems. Similarly, any other type of optical amplifiers may be used, such as for example semiconductor optical amplifiers (SOAs) or Raman amplifiers.

Communication system 30 also includes a corresponding optical pulse compressor 36 which is optically inserted between the optical transmission medium and the demultiplexer 26. The compressor 36 operates on the pulses by temporally compressing (or temporally de-chirping) them, thus substantially reconstructing the narrow pulses in each wavelength channel that were initially produced by the associated modulator 14 for that wavelength channel. The inventive transmission format is henceforth referred to as “chirped-pulse transmission” (CPT). The individual optical wavelength channels are then directly detected by associated detectors 29 in the receiver array 28. Each individual detector 29 converts the reconstructed modulated optical signal pulses in each wavelength channel to associated modulated electrical signal pulses which are then filtered by an electrical filter having a predefined filter bandwidth connected to each detector 29 for removing out-of-band frequency components due to four wave mixing of the multiplexed at least two modulated optical signal pulses.

In network 30, the optical signal pulse stretcher 34 may apply a linear chirp of given slope to the multiplexed modulated optical signal pulses, and the optical pulse compressor 36 applies a linear chirp which has a slope of opposite sign to that applied by the stretcher 34.

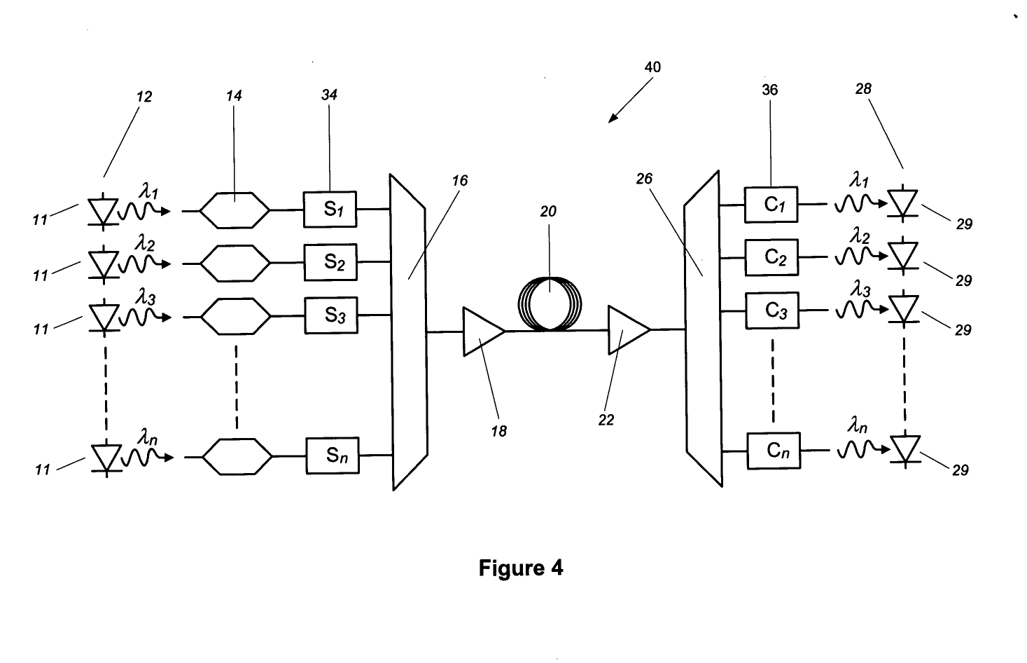

Referring now to FIG. 4, a preferred embodiment of the invention is shown generally at 40 and includes a plurality of pulse stretchers 34 and a plurality of pulse compressors 36 with a pulse stretcher 34 and an individual pulse compressor 36 associated with each channel. As shown in FIG. 4, the stretchers 34 are placed before the multiplexer 16 and the compressors 36 are placed after the demultiplexer 26. Unlike the single broadband stretcher and compressor modules shown in FIG. 3, these channelized modules may have different chirp values in order to optimize the system for FWM generation and/or chromatic dispersion compensation.

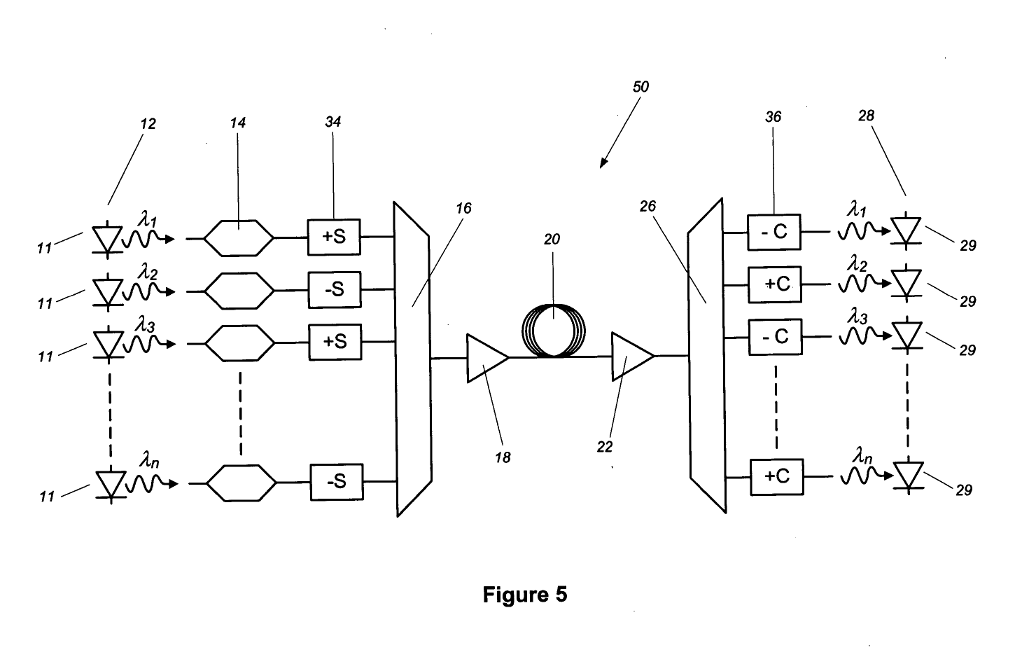

Referring to FIG. 5, another preferred embodiment of the optical communication system 50 is based on the system 40 shown in FIG. 4. In system 50, the pulse stretchers 34 and compressors 36 associated with the different wavelength channels each have alternating values of positive and negative chirp, so that adjacent wavelength channels have opposite chirp profiles when propagating through the fiber. The pulse stretcher 34 and compressor 36 associated with a given wavelength channel have opposite chirp signs. Other arrangements of chirp signs among different stretchers are also possible.

In yet another preferred embodiment of the invention based on system 40 of FIG. 4, each stretcher 34 provides a linear chirp to the modulated pulses. Each compressor 36 provides the opposite chirp as the stretcher so that the input pulse shapes are regenerated prior to detection. In systems with substantially zero chromatic dispersion, the stretcher and compressor modules provide equal and opposite chirp. However, in systems with sufficient chromatic dispersion to cause pulse distortion, the stretcher and compressor chirp values can be made unequal so as to compensate for the linear dispersion of the transmission link. Other realizations of the invention that employ nonlinear chirp are also possible.

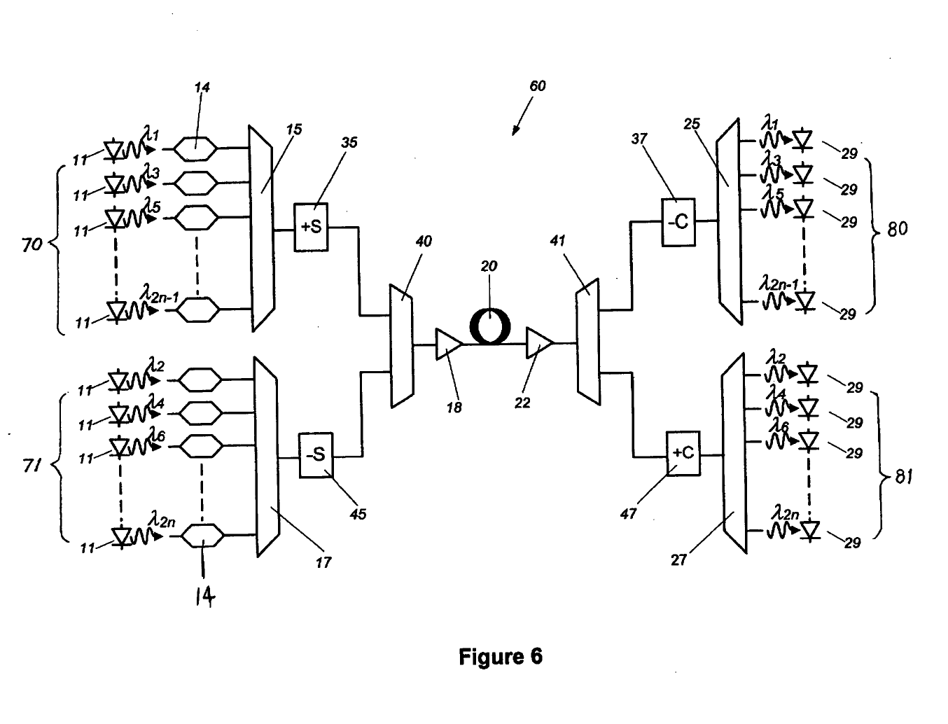

Referring to FIG. 6, another embodiment of the optical communication system shown generally at 60 uses the channel-interleaving concept. This system includes an array 70 of parallel continuous wave (CW) lasers 11 each emitting optical signal pulses in odd wavelength channels with each light source 11 optically coupled to an associated modulator 14 which modulates the light beam with the outputs of all the modulators 14 being multiplexed via multiplexer 15. Similarly, an array 71 of parallel continuous wave (CW) lasers 11 each emitting optical signal pulses in even wavelength channels has each light source 11 optically coupled to an associated modulator 14 which modulates the light beam with the outputs of all the modulators 14 in array 71 being multiplexed via multiplexer 17.

Having been multiplexed by their respective multiplexer 15 and 17, both the odd and even wavelength channels are stretched by their respective pulse stretchers 35 and 45 before they are mixed using a channel interleaver 40. After both odd and even channels are transmitted through optical fiber 20, they are de-interleavered by de-interleaver 41 and sent to their respective pulse compressors 37 and 47 before they are de-multiplexed by corresponding de-multiplexers 25 and 27. Thus, in the optical circuit shown in FIG. 6 even and odd wavelength channels are stretched and compressed separately in which adjacent channels are again chirped by stretchers and compressors with chirp values of alternating signs, yet using only two pairs of stretchers and compressors for all channels.

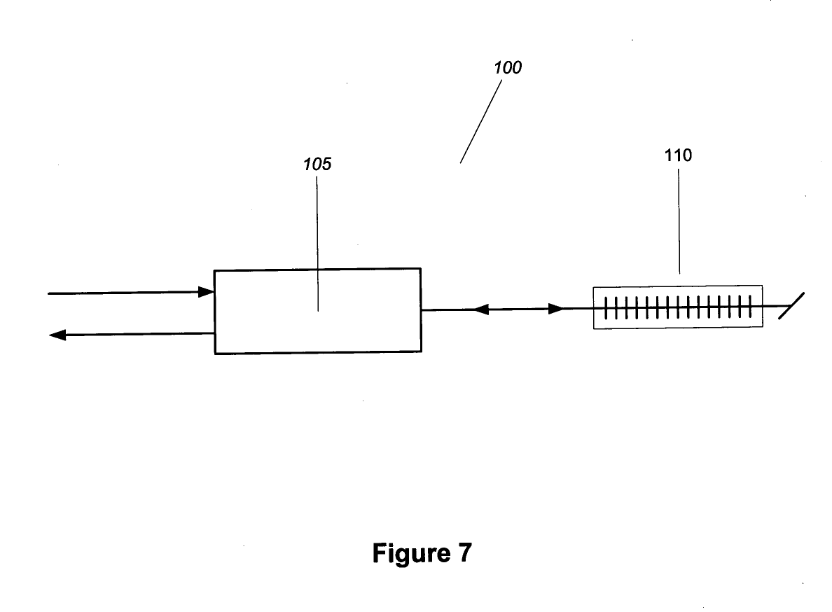

The stretcher and compressor modules in all the embodiments shown in FIGS. 3 to 6 can be produced using a number of technologies that will be well known to those skilled in the art. By way of example, two single-mode fibers with opposite dispersion can be used to form the stretcher and compressor. Alternatively, a pair of free-space diffraction gratings can be used to stretch or compress the pulses. In another example, chirped fiber Bragg gratings may be used in reflection to stretch or compress the optical pulses, as shown in FIG. 7. The stretcher or compressor 100 operates by transmitting the optical pulses through an optical branch device 105, reflecting them off a chirped fiber Bragg grating 110 and re-transmitting them to the output port of the optical branch device.

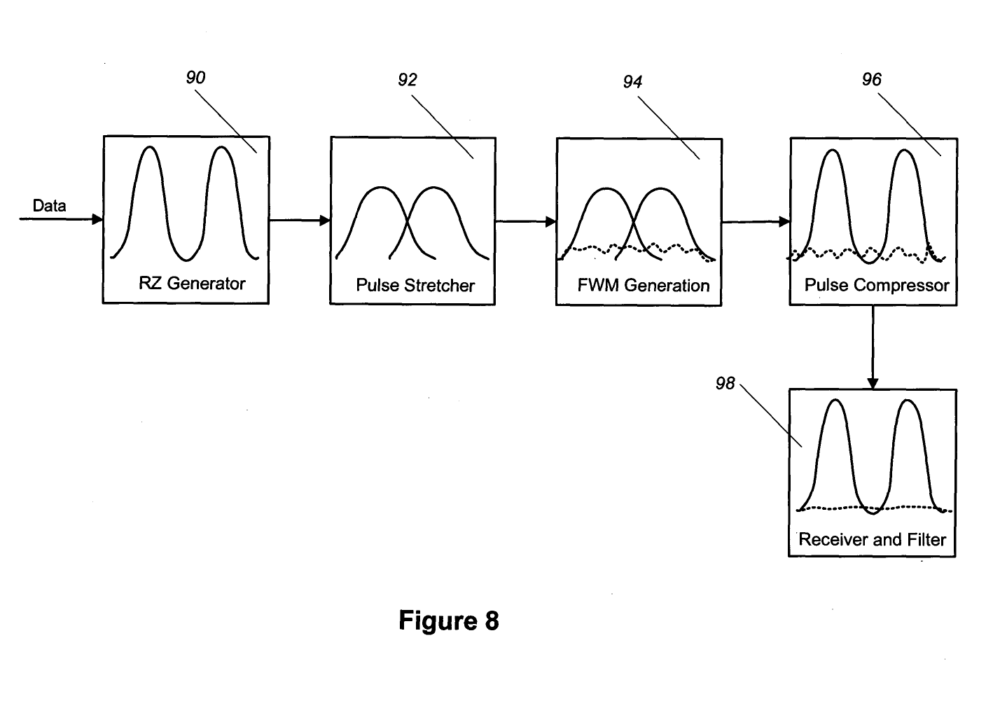

The general physical principle underlying the operation of the CPT system will now be described with reference to FIG. 8. A qualitative comparison between the invention and the representative prior art transmission scheme is obtained by considering the propagation of optical pulses through the system. If NRZ (or RZ) pulses are used without the stretcher-compressor pair, then FWM products are generated and transmitted together with the signals through the electrical filter, degrading the system performance. This occurs primarily due to the fact that the FWM products share the same bandwidth as the signal and thus cause in-band cross talk even after electrical filtering.

We now consider the multiple benefits provided by the present invention. With reference to both FIGS. 3 and 8, RZ pulses generated by the modulators 14 in the different wavelength channels (shown in box 90 of FIG. 8) are multiplexed by multiplexer 16 and are then stretched in space and time (temporally chirped) by the pulse stretcher 34 to give the pulses shown in box 92 of FIG. 8. If the stretcher 34 is not included, then the high peak power of the RZ pulses will generate FWM with high efficiency in the zero-dispersion regime. By stretching the pulses, the peak power is reduced and hence the generated FWM power is lessened.

As the stretched optical signal pulses propagate through the low-dispersion optical fiber, FWM products are generated as shown in box 94 in FIG. 8. Since the bandwidth of the RZ pulses is larger than that of NRZ pulses, the power of the FWM products is generated over a broader bandwidth. Furthermore, the operation of stretching the pulses introduces a frequency chirp that modifies the FWM generation process and introduces further spectral broadening of the FWM products. When the signal and FWM products encounter the pulse compressor 36, the signal pulses are efficiently recompressed into narrow RZ pulses as shown in box 96 of FIG. 8.

However, since the FWM products have a completely different time-dependent chirp profile, they are not efficiently recompressed and remain broadened in time. This effect can be further enhanced by alternating the sign of the frequency chirp applied to adjacent channels as shown in FIG. 5. In addition to the broad temporal distribution of the FWM products, the large bandwidth and complicated chirp profile causes a large amount of high-frequency temporal structure. These high-frequency components are efficiently filtered upon transmission through the low-pass electrical filter (as depicted in box 98 of FIG. 8) which is part of each optical signal detector circuit 29.

Therefore, after de-chirping by compressor 36 narrow RZ pulses similar to the original RZ pulses that were temporally chirped are reconstructed, and after demultiplexing by demultiplexer 26 (FIG. 3) the reconstructed pulses in their wavelength channels are then directly detected by associated detectors 29 in the receiver array 28. The reconstructed modulated optical signal pulses in each wavelength channel are converted by its associated optical signal detector 29 to modulated electrical signal pulses which are then filtered by the electrical filter having a predefined filter bandwidth connected to each detector 29 which removes the out-of-band frequency components due to four wave mixing (FWM) of the multiplexed at least two modulated optical signal pulses.

The suppression of the out-of-band FWM power leads to a dramatic improvement in system performance. Additional improvement in performance is provided by the sensitivity gain of RZ over NRZ transmission, which is approximately 2 dB.

The performance enhancement provided by the CPT format can be quantified by considering the numerical example that was previously discussed in the context of typical NRZ and RZ systems. The example is now modified to reflect the new format by using RZ transmission and including the stretcher 34 and compressor 36 modules as shown in the circuit of FIG. 5. The stretcher and compressor modules provide ±625 ps/nm linear dispersion, each with opposite signs. This amount of linear dispersion was chosen to provide sufficient broadening to produce a significant performance improvement while ensuring that individual bits did not substantially broaden into adjacent bit slots. Simulations have revealed that a wide range of dispersion values around this value may be used to obtain the purported performance improvement. Furthermore, the sign of the dispersion for both the stretcher and compressor modules is reversed for adjacent channels to provide alternating frequency chirp profiles. The channel spacing, channel count and properties of the transmission fiber are kept identical to those of the previous example so that a meaningful comparison can be drawn.

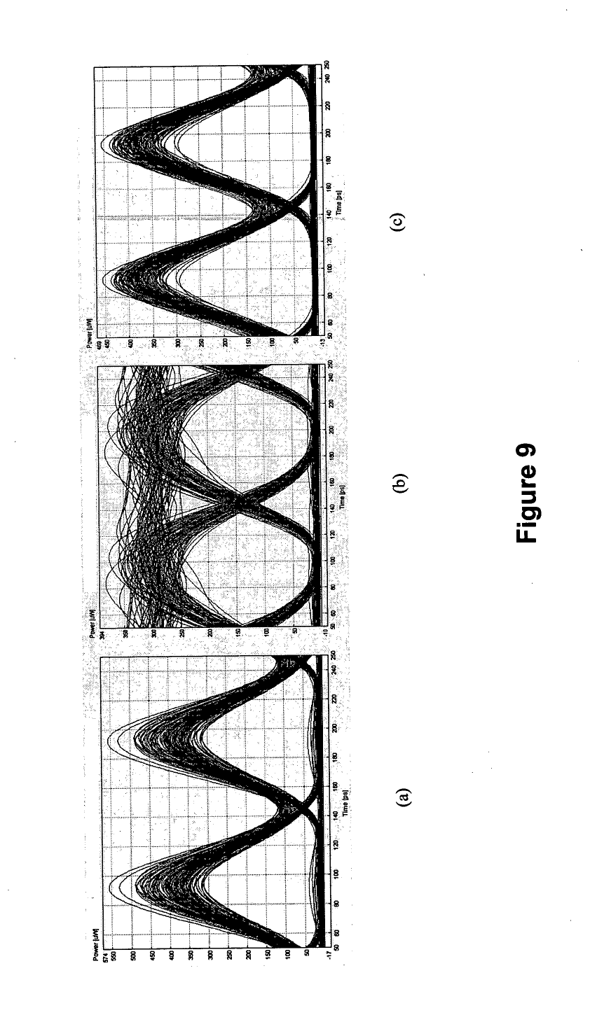

The eye diagrams for the worst-case channels of (a) RZ, (b) NRZ and (c) CPT systems are shown in FIG. 9. The average optical power launched into the fiber is −1 dBm in all cases. The eye opening of the CPT system is significantly higher than both RZ and NRZ systems.

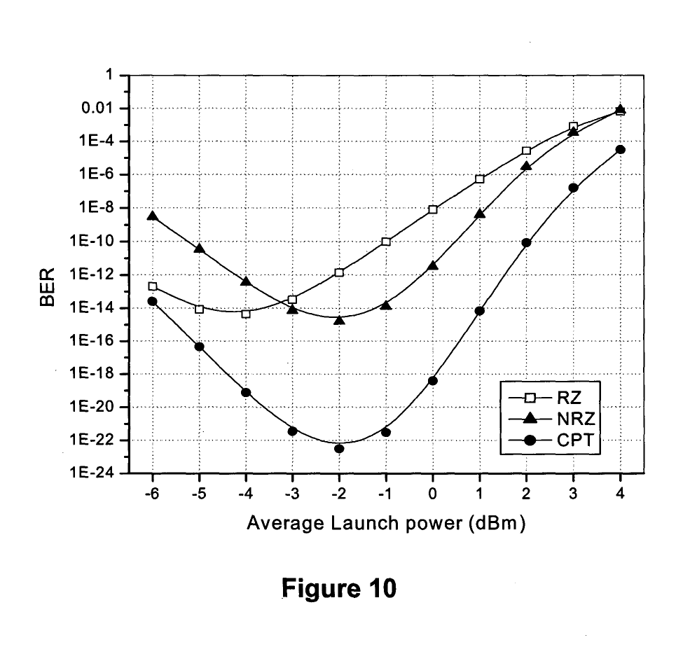

The enhanced system margin provided by the CPT system can be further quantified by plotting the BER as a function of launch power, as shown in FIG. 10. This plot reveals that the BER drops below 10⁻²². Comparing the CPT results with those of the RZ and the NRZ systems, one readily observes that a BER improvement of approximately 8 orders of magnitude is achieved, with a corresponding Q-factor enhancement of about 2 dB.

As those of ordinary skill of the art will recognize, the above examples of the CPT system can be generalized to provide performance enhancement to many different types of WDM transmission systems. Although the exemplary network discussed in the preceding section was a single-span network, the CPT format is easily adaptable to multi-span networks. For example, in a two-span system, an intermediate dispersive element may be placed at the mid-span point that reverses the pulse chirp (in which case the sign of the chirp of the compressor at the receiver the same as that of the initial stretcher) so that the pulses remain stretched by the same amount. This may also be done in conjunction with channelized delay lines with lengths beyond the transmitter coherence length, as suggested in the prior art.

Finally, although the CPT format has been discussed solely in the context of RZ transmission mode, it is possible to design mixed systems with RZ-CPT and NRZ formats. In particular, in cases where the zero-dispersion wavelength is restricted to a sufficiently narrow band, the CPT format may be used for the channels in the vicinity of the zero-dispersion band, while the traditional NRZ format may be used on out-of-band channels that do not suffer from severe FWM as a result of dispersion-induced phase mismatch. Alternatively, a mixed system with an NRZ channel between two oppositely chirped CPT channels (with this pattern repeated over many channels) can be used to enhance the system performance with minimal additional cost. Lastly, a plurality of CPT format channels can be added (as an upgrade) to an existing system with sparse NRZ channels to enhance the system capacity.

In this embodiment of the invention using a mixed RZ and NRZ formats the method of suppressing four wave mixing in a wavelength-division multiplexed optical communication network, comprises a) generating optical signal pulses in at least two wavelength channels and modulating the optical signal pulses in each of the at least two wavelength channels for encoding information onto the optical signal pulses in each of the at least two wavelength channels; b) temporally chirping the modulated optical signal pulses in at least some, but not all, of the at least two wavelength channels; c) multiplexing the temporally chirped modulated optical signal pulses in the at least some, but not all, of the at least two wavelength channels and the modulated optical signal pulses in the remaining wavelength channels; d) transmitting the multiplexed temporally chirped and non-chirped modulated optical signal pulses through an optical transmission medium to a receiver; e) demultiplexing the multiplexed temporally chirped and non-chirped modulated optical signal pulses to reconstruct the temporally chirped and non-chirped modulated optical signal pulses in each of the at least two wavelength channels; f) temporally de-chirping the temporally chirped modulated optical signal pulses in each of the at least some, but not all wavelength channels to reconstruct the modulated optical signal pulses in each of the at least some, but not all wavelength channels; g) detecting and converting the reconstructed modulated optical signal pulses in each of the at least two wavelength channels to associated modulated electrical signal pulses; and h) filtering the associated modulated electrical signal pulses to remove out-of-band high frequency components due to four wave mixing of the multiplexed modulated optical signal pulses in each of the at least two wavelength channels.

The method includes producing modulated optical signals pulses in a return-to-zero (RZ) format only in those wavelength channels which are temporally chirped, and includes producing modulated signal pulses in a non-return-to-zero (NRZ) format in the wavelength channels which are not temporally chirped.

Further, a wavelength-division multiplexed optical communication network device using mixed NRZ and RZ transmission modes comprises
a) an optical signal transmitter which includes, i) an optical signal source array having at least two optical signal sources, each optical signal source producing optical signal pulses in a respective wavelength channel associated therewith, each of said at least two optical signal sources being optically coupled to an associated optical signal modulator for modulating the optical signal pulses that are output from the optical signal source coupled thereto to encode information onto the optical signal pulses in each of the respective wavelength channels, ii) at least some, but not all, of the optical signal modulators being optically coupled to an input of an associated optical signal pulse stretcher for temporally chirping the modulated optical signal pulses in some, but not all, of the wavelength channels. The network includes iii) a multiplexer, each optical signal pulse stretcher including an output being optically coupled to said multiplexer and the optical signal modulators not connected to an associated optical signal pulse stretcher being optically coupled to said multiplexer for multiplexing the temporally chirped and non-temporally chirped modulated optical signal pulses in all the wavelength channels; iv) an optical transmission medium optically coupled to an output of the multiplexer through which the multiplexed temporally chirped and non-temporally chirped modulated optical signal pulses are transmitted; and b) an optical signal receiver optically coupled to the optical transmission medium for receiving the multiplexed temporally chirped and non-chirped modulated optical signal pulses. The optical signal receiver includes i) a demultiplexer having an input being optically coupled to the optical transmission medium for demultiplexing the multiplexed temporally-chirped and non-chirped modulated optical signal pulses for reconstructing the temporally-chirped and non-chirped modulated optical signal pulses in each of the respective wavelength channels; ii) a number of optical signal compressors each having an input optically coupled to an output of the demultiplexer for temporally dechirping the demultiplexed temporally chirped modulated optical signal pulses in said some, but not all, of the wavelength channels to reconstruct the modulated optical signal pulses in each of the respective wavelength channels; and iii) an optical detector array including at least as many optical detectors as wavelength channels, some, but not all, of the optical detectors being optically coupled to an output of an associated optical signal pulse compressor for converting the reconstructed modulated optical signal pulses in the wavelength channels which were temporally chirped to modulated electrical signal pulses, and the remaining optical detectors being optically connected directly to an output of the demultiplexer for converting the modulated optical signal pulses in the wavelength channels that were not temporally chirped to modulated electrical signal pulses, each optical detector having an associated filter electrically connected thereto for filtering the modulated electrical signal pulses produced therein with each filter having a pre-defined filter bandwidth for removing out-of-band frequency components due to four wave mixing arising from multiplexing the modulated optical signal pulses in all the wavelength channels.

In this optical communication network the at least some, but not all, of the optical signal modulators coupled to an input of an associated optical signal pulse stretcher produce modulated optical signals pulses in a return-to-zero (RZ) format in the wavelength channels which are temporally chirped, and wherein the remaining optical signal modulators not connected to a pulse stretcher produces modulated signal pulses in a non-return-to-zero (NRZ) format in the wavelength channels which are not temporally chirped.

The network may be configured in such a way that a sign of the temporal chirp applied by the optical signal pulse stretchers may vary on a per wavelength channel basis, wherein for a given wavelength channel, a sign of the temporal chirp of the compressor is chosen to be opposite to that of the applied by the stretcher corresponding to the given wavelength channel.

The network may be configured in such a way that the optical signal pulse stretchers and the optical signal pulse compressors may apply alternating values of positive and negative chirp, so that adjacent wavelength channels have opposite chirp signs when propagating through the optical fiber.

The network may be configured in such a way that each optical signal pulse stretcher for temporally chirping the optical signal pulses may have the same chirp value, and wherein each optical signal pulse compressor for temporally de-chirping the optical signal pulses may apply a different chirp value to offset effects of chromatic dispersion of the optical transmission medium on each wavelength channel.

The network may be configured so that each optical signal pulse stretcher may apply a linear temporal chirp of given slope to the modulated optical signal pulses in the respective wavelength channel associated therewith, and wherein the optical pulse compressor associated with the given wavelength channel applies a linear chirp with a slope of opposite sign to said given slope.

The network may be configured so that there are two optical amplifiers, an optical boost amplifier being optically inserted between the multiplexer and the optical fiber, and wherein an optical pre-amplifier is optically inserted between the optical fiber and the demultiplexer.

The network may be configured so that there are at least two spans of optical fiber, and including an optical dispersive element inserted between the two spans of optical fiber for reversing a sign of the temporal chirp applied to the optical pulses in each wavelength channel, and wherein each optical pulse compressor has an appropriate magnitude and sign to substantially reconstruct the optical pulses in its respective wavelength channel. At least one optical boost amplifier may be inserted between the two spans of optical fiber.

Those skilled in the art will appreciate the advantageous features of the present invention relative to the prior art. Most importantly, the systems disclosed herein provide a method of achieving a large increase in system capacity with a sufficiently large performance enhancement to provide a large reach. Unlike most other solutions, particularly those that rely on polarization or mid-span cancellation, the present invention does not suffer from environmental variations due to PMD. Furthermore, the compensating elements in the invention are passive and therefore a large reliability premium relative to active solutions. The passive nature of the design and the simplicity of its implementation is also advantageous for its cost savings and ease of management. Furthermore, the CPT format may be used in conjunction with other pulse modulation formats and other fiber types. The format may also be used in conjunction with other prior art solutions including polarization multiplexing, Raman amplification and forward error correction. The optical communication network may include a microprocessor connected to the optical communication network for performing forward error correction to further enhance the system performance or this feature may be included in the hardware.

As used herein, the terms “comprises” and “comprising” are to be construed as being inclusive and open ended, and not exclusive. Specifically, when used in this specification including claims, the terms “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims.

1. A wavelength-division multiplexed optical communication network, comprising:
a) an optical signal transmitter including,
i) an optical signal source array having at least two optical signal sources, each optical signal source producing optical signal pulses in a wavelength channel associated therewith, each of the at least two optical signal sources being optically coupled to an associated optical signal modulator for modulating the optical signal pulses that are output from the optical signal source coupled thereto to encode information onto the optical signal pulses in each wavelength channel,
ii) a multiplexer, each optical signal modulator having an output being optically coupled to the multiplexer for multiplexing the modulated optical signal pulses in all the wavelength channels,
iii) an optical signal pulse stretcher being optically coupled to an output of the multiplexer for temporally chirping the multiplexed modulated optical signal pulses;
iv) an optical fiber having opposed ends being optically coupled at one of the opposed ends to an output of the optical signal pulse stretcher through which the temporally chirped multiplexed modulated optical signal pulses are transmitted; and
b) an optical signal receiver optically coupled to the optical fiber for receiving the temporally chirped multiplexed modulated optical signal pulses, the optical signal receiver including,
i) an optical signal pulse compressor having an input optically coupled to the other of the opposed ends of the optical fiber for temporally de-chirping the temporally chirped multiplexed modulated optical signal pulses for reconstructing the multiplexed modulated optical signal pulses,
ii) a demultiplexer having an input optically coupled to an output of the optical signal pulse compressor for demultiplexing the reconstructed multiplexed modulated optical signal pulses to reconstruct the modulated optical signal pulses in each of the wavelength channels, and
iii) an array of optical detectors, each of the optical detectors being connected to an associated output of the demultiplexer for converting the reconstructed modulated optical signal pulses in each wavelength channel to modulated electrical signal pulses, each optical detector including a filter electrically connected thereto for filtering the modulated electrical signal pulses produced therein with each filter having a predefined filter bandwidth for removing out-of-band frequency components due to four wave mixing arising from multiplexing the modulated optical signal pulses in the wavelength channels.

2. The optical communication network according to claim 1 wherein the optical signal modulators produce modulated optical signals pulses in a return-to-zero (RZ) format.

3. The optical communication network according to claim 2 including at least one optical amplifier inserted between optical signal pulse stretcher and the optical signal pulse compressor for amplifying the temporally-chirped multiplexed modulated optical signal pulses.

4. The optical communication network according to claim 3 wherein the at least one optical amplifier is two optical amplifiers, an optical boost amplifier being inserted between the optical signal pulse stretcher and the optical fiber, and wherein an optical pre-amplifier is inserted between the optical fiber and the optical signal pulse compressor.

5. The optical communication network according to claim 4 wherein the two amplifiers are erbium-doped fiber amplifiers (EDFAs).

6. The optical communication network according to claim 4 wherein the two amplifiers are semiconductor optical amplifiers (SOAs) or Raman amplifiers.

7. The optical communication network according to claim 2 wherein the optical fiber includes at least two spans of optical fiber, including at least one optical boost amplifier inserted between the at least two spans of optical fiber.

8. The optical communication network according to claim 2 wherein the optical signal pulse stretcher applies a linear chirp of given slope to the multiplexed modulated optical signal pulses, and wherein the optical pulse compressor applies a linear chirp to the temporally chirped multiplexed modulated optical signal pulses which has a slope of opposite sign to the given slope.

9. The optical communication network according to claim 2 wherein the optical fiber includes at least two spans of optical fiber, and including an optical dispersive element inserted between the at least two spans of optical fiber for reversing a sign of the temporal chirp applied to the optical signal pulses in each wavelength channel, and wherein the optical pulse compressor has an appropriate magnitude and sign to substantially reconstruct the optical signal pulses.

10. The optical communication network according to claim 9 including at least one optical boost amplifier inserted between the at least two spans of optical fiber.

11. The optical communication network according to claim 2 wherein the optical signal pulse stretcher includes a chirped fiber Bragg grating optically coupled to an optical branch device, and wherein a chirp of the chirped fiber Bragg grating is chosen in such a way that the optical pulses are stretched by a desired amount, and wherein the optical signal pulse compressor includes a chirped fiber Bragg grating optically coupled to an optical branch device, and wherein a chirp of the chirped fiber Bragg grating is chosen in such a way that the optical pulses are compressed by a desired amount.

12. The optical communication network according to claim 2 wherein the optical signal pulse stretcher includes a segment of dispersive optical fiber having a chromatic dispersion value chosen in such a way that the optical pulses are stretched by an appropriate amount, and wherein the optical signal pulse compressor includes a segment of dispersive optical fiber having a chromatic dispersion value chosen in such a way that the optical pulses are compressed by an appropriate amount.

13. The optical communication network according to claim 2 including processing means connected to the optical communication network for performing forward error correction to further enhance the system performance.

14. A wavelength-division multiplexed optical communication network, comprising:
a) an optical signal transmitter including,
i) an optical signal source array having at least two optical signal sources, each optical signal source producing optical signal pulses in a wavelength channel associated therewith, each of the at least two optical signal sources being optically coupled to an associated optical signal modulator for modulating the optical signal pulses that are output from the optical signal source coupled thereto to encode information onto the optical signal pulses in each of the wavelength channels,
ii) each optical signal modulator being optically coupled to an input of an associated optical signal pulse stretcher for temporally chirping the modulated optical signal pulses produced in the optical signal modulator coupled thereto,
iii) a multiplexer, each optical signal pulse stretcher including an output being optically coupled to the multiplexer for multiplexing the temporally chirped modulated optical signal pulses in all the wavelength channels;
iv) an optical fiber having opposed ends being optically coupled at one of the opposed ends to an output of the multiplexer through which the multiplexed temporally chirped modulated optical signal pulses are transmitted; and
b) an optical signal receiver optically coupled to the optical fiber for receiving the multiplexed temporally chirped modulated optical signal pulses, the optical signal receiver including,
i) a demultiplexer having an input being optically coupled to the other of the opposed ends of the optical fiber for demultiplexing the multiplexed temporally-chirped modulated optical signal pulses for reconstructing the temporally-chirped modulated optical signal pulses in each of the wavelength channels;
ii) an array of optical signal pulse compressors, each optical pulse compressor having an input optically coupled to an output of the demultiplexer for temporally de-chirping the demultiplexed temporally chirped modulated optical signal pulses to reconstruct the modulated optical signal pulses in each of the respective wavelength channels; and
iii) an array of optical detectors, each optical detector being optically coupled to an output of an associated optical signal pulse compressor for converting the reconstructed modulated optical signal pulses in each wavelength channel to modulated electrical signal pulses, each optical detector including a filter electrically connected thereto for filtering the modulated electrical signal pulses with each filter having a pre-defined filter bandwidth for removing out-of-band frequency components due to four wave mixing arising from multiplexing the modulated optical signal pulses in all the wavelength channels.

15. The optical communication network according to claim 14 wherein the optical signal modulators produce modulated optical signals pulses in a return-to-zero (RZ) format.

16. The optical communication network according to claim 15 including at least one optical amplifier inserted between the multiplexer and the demultiplexer for amplifying the multiplexed temporarily chirped modulated optical signal pulses.

17. The optical communication network according to claim 16 wherein the at least one optical amplifier is two optical amplifiers, an optical boost amplifier being optically inserted between the multiplexer and the optical fiber, and wherein an optical pre-amplifier is optically inserted between the optical fiber and the demultiplexer.

18. The optical communication network according to claim 17 wherein said two amplifiers are erbium-doped fiber amplifiers (EDFAs).

19. The optical communication network according to claim 17 wherein said two amplifiers are semiconductor optical amplifiers (SOAs) or Raman amplifiers.

20. The optical communication network according to claim 15 wherein the optical fiber includes at least two spans of optical fiber, including at least one optical boost amplifier inserted between said at least two spans of optical fiber.

21. The optical communication network according to claim 20 wherein including an optical boost amplifier optically inserted between the multiplexer and the optical fiber in a first of the at least two spans of optical fiber, and wherein an optical pre-amplifier is optically inserted between the optical fiber in a second of the at least two spans of optical fiber and the demultiplexer.

22. The optical communication network according to claim 15 wherein a sign of the temporal chirp applied by the optical signal pulse stretchers may vary on a per wavelength channel basis, wherein for a given wavelength channel, a sign of the temporal chirp of the compressor is chosen to be opposite to that applied by the corresponding stretcher to the given wavelength channel.

23. The optical communication network according to claim 22 wherein the optical signal pulse stretchers and optical signal pulse compressors apply alternating values of positive and negative chirp, so that adjacent wavelength channels have opposite chirp signs when propagating through the optical fiber.

24. The optical communication network according to claim 15 wherein each optical signal pulse stretcher for temporally chirping the optical signal pulses has the same chirp value, and wherein each optical signal pulse compressor for temporally de-chirping the optical signal pulses applies a different chirp value to offset effects of chromatic dispersion of the optical transmission medium on each wavelength channel.

25. The optical communication network according to claim 15 wherein each optical signal pulse stretcher applies a linear temporal chirp of given slope to the modulated optical signal pulses in the respective wavelength channel associated therewith, and wherein the optical pulse compressor associated with said given wavelength channel applies a linear chirp with a slope of opposite sign to the given slope.

26. The optical communication network according to claim 15 wherein the optical fiber includes at least two spans of optical fiber, and including an optical dispersive element inserted between said at least two spans of optical fiber for reversing a sign of the temporal chirp applied to the optical pulses in each wavelength channel, and wherein each optical pulse compressor has an appropriate magnitude and sign to substantially reconstruct the optical pulses in its respective wavelength channel.

27. The optical communication network according to claim 26 including at least one optical boost amplifier inserted between the at least two spans of optical fiber.

28. The optical communication network according to claim 15 wherein the optical signal pulse stretcher includes a chirped fiber Bragg grating optically coupled to an optical branch device, and wherein a chirp of the chirped fiber Bragg grating is chosen in such a way that the optical pulses are stretched by a desired amount, and wherein the optical signal pulse compressor includes a chirped fiber Bragg grating optically coupled to an optical branch device, and wherein a chirp of the chirped fiber Bragg grating is chosen in such a way that the optical pulses are compressed by a desired amount.

29. The optical communication network according to claim 15 wherein the optical signal pulse stretcher includes a segment of dispersive optical fiber having a chromatic dispersion value chosen in such a way that the optical pulses are stretched by an appropriate amount, and wherein the optical signal pulse compressor includes a segment of dispersive optical fiber having a chromatic dispersion value chosen in such a way that the optical pulses are compressed by an appropriate amount.

30. The optical communication network according to claim 15 including processing means connected to the optical communication network for performing forward error correction to further enhance the system performance.

31. A method of suppressing four-wave mixing in a wavelength-division multiplexed optical communication network, comprising the steps of:
a) generating optical signal pulses in at least two wavelength channels and modulating the optical signal pulses in each of said at least two wavelength channels for encoding information onto the optical signal pulses in each of said at least two wavelength channels;
b) multiplexing the modulated optical signal pulses in each of said at least two wavelength channels;
c) temporally chirping the multiplexed modulated optical signal pulses;
d) transmitting the temporally chirped multiplexed modulated optical signal pulses through an optical fiber to a receiver;
e) temporally de-chirping the temporally chirped multiplexed modulated optical signal pulses at the receiver optically coupled to the optical fiber for reconstructing the originally multiplexed modulated optical signal pulses;
f) demultiplexing the de-chirped multiplexed modulated optical signal pulses to reconstruct the modulated optical signal pulses in each of said at least two wavelength channels;
g) detecting and converting the reconstructed modulated optical signal pulses in each of said at least two wavelength channels to associated modulated electrical signal pulses; and
h) filtering said associated modulated electrical signal pulses to remove out-of-band high frequency components due to four wave mixing of the multiplexed modulated optical signal pulses in each of said at least two wavelength channels.

32. The method according to claim 31 wherein the step of modulating the optical signal pulses in each of said at least two wavelength channels includes producing modulated optical signals pulses in a return-to-zero (RZ) format.

33. The method according to claim 32 including amplifying the temporally chirped multiplexed modulated optical signal pulses.

34. The method according to claim 33 wherein the temporally chirped multiplexed modulated optical signal pulses are amplified using one or more erbium-doped fiber amplifier (EDFAs).

35. The method according to claim 33 wherein the temporally chirped multiplexed modulated optical signal pulses are amplified using one or more semiconductor optical amplifier (SOAs) or Raman amplifiers.

36. The method according to claim 33 wherein the temporally chirped multiplexed modulated optical signal pulses are amplified using two optical amplifiers, one of the two optical amplifiers being an optical boost amplifier and the other amplifier being an optical pre-amplifier.

37. The method according to claim 32 wherein the optical fiber includes at least two spans of optical fiber, including at least one optical boost amplifier inserted between the at least two spans of optical fiber.

38. The method according to claim 32 wherein the step of temporally chirping the multiplexed modulated optical signal pulses includes applying a linear chirp of given slope to the multiplexed modulated optical signal pulses in all of the at least two wavelength channels, and wherein the step of temporally de-chirping the temporally chirped multiplexed modulated optical signal pulses includes
applying a linear chirp to the temporally chirped multiplexed modulated optical signal pulses which has a slope of opposite sign to the given slope.

39. The method according to claim 32 wherein the optical fiber includes at least two spans of optical fiber, and including an optical dispersive element inserted between said at least two spans of optical fiber for reversing a sign of the temporal chirp applied to the optical pulses in each wavelength channel, and wherein the step of temporally de-chirping the temporally chirped multiplexed modulated optical signal pulses includes applying a de-chirp value having an appropriate magnitude and sign to substantially reconstruct the optical pulses.

40. The method according to claim 39 wherein the temporally chirped multiplexed modulated optical signal pulses are amplified by an optical boost amplifier inserted between the at least two spans of optical fiber.

41. The method according to claim 32 wherein forward error correction is used to further enhance the system performance.

42. The method according to claim 32 wherein the step of temporally chirping the multiplexed modulated optical signal pulses for stretching the multiplexed modulated optical signal pulses includes
a) transmitting the multiplexed modulated optical signal pulses through an optical branch device,
b) reflecting the multiplexed modulated optical signal pulses using an optically chirped fiber Bragg grating with a chirp value chosen in such a way that the optical pulses are stretched by a selected amount, and
c) re-transmitting the stretched reflected multiplexed modulated optical signal pulses back through the optical branch device.

43. The method according to claim 32 wherein the step of temporally de-chirping the multiplexed modulated optical signal pulses for compressing the multiplexed modulated optical signal pulses back to their original pulse shapes includes
a) transmitting the multiplexed modulated optical signal pulses through an optical branch device,
b) reflecting the temporally chirped multiplexed modulated optical signal pulses using an optically chirped fiber Bragg grating with a chirp value chosen in such a way that the optical pulses are compressed by a selected amount to give the original pulse shapes, and
c) re-transmitting the compressed reflected multiplexed modulated optical signal pulses back through the optical branch device.

44. The method according to claim 32 wherein the step of temporally chirping the multiplexed modulated optical signal pulses for stretching the multiplexed modulated optical signal pulses includes transmitting the multiplexed modulated optical signal pulses through a dispersive optical fiber having a chromatic dispersion value chosen in such a way that the multiplexed modulated optical signal pulses are stretched by the appropriate amount.

45. The method according to claim 32 wherein the step of temporally de-chirping the multiplexed modulated optical signal pulses for compressing the multiplexed modulated optical signal pulses to give the original pulse shapes includes transmitting the multiplexed modulated optical signal pulses through a dispersive optical fiber having a chromatic dispersion value chosen in such a way that the multiplexed modulated optical signal pulses are compressed by the appropriate amount to give the original optical signal pulse shapes.

46. A method of suppressing four wave mixing in a wavelength-division multiplexed optical communication network, comprising the steps of:
a) generating optical signal pulses in at least two wavelength channels and modulating the optical signal pulses in each of the at least two wavelength channels for encoding information onto the optical signal pulses in each of the at least two wavelength channels;
b) temporally chirping the modulated optical signal pulses in each of the at least two wavelength channels;
c) multiplexing the temporally chirped modulated optical signal pulses in each of the at least two wavelength channels;
d) transmitting the multiplexed temporally chirped modulated optical signal pulses through an optical fiber to a receiver;
e) demultiplexing the multiplexed temporally chirped modulated optical signal pulses received at the receiver to reconstruct the temporally chirped modulated optical signal pulses in each of the at least two wavelength channels;
f) temporally de-chirping the temporally chirped modulated optical signal pulses in each of the at least two wavelength channels to reconstruct the modulated optical signal pulses in each of the at least two wavelength channels;
g) detecting and converting the reconstructed modulated optical signal pulses in each of the at least two wavelength channels to associated modulated electrical signal pulses; and
h) filtering the associated modulated electrical signal pulses to remove out-of-band high frequency components due to four wave mixing of the multiplexed modulated optical signal pulses in each of the at least two wavelength channels.

47. The method according to claim 46 wherein the step of modulating the optical signal pulses in each of said at least two wavelength channels includes producing modulated optical signals pulses in a return-to-zero (RZ) format.

48. The method according to claim 47 including amplifying the multiplexed temporally chirped modulated optical signal pulses.

49. The method according to claim 48 wherein the multiplexed temporally chirped modulated optical signal pulses are amplified using one or more erbium-doped fiber amplifiers (EDFAs).

50. The method according to claim 48 wherein the multiplexed temporally chirped modulated optical signal pulses are amplified using one or more semiconductor optical amplifiers (SOAs) or Raman amplifiers.

51. The method according to claim 48 wherein the multiplexed temporally chirped modulated optical signal pulses are amplified using two optical amplifiers, one of said optical amplifiers being an optical boost amplifier and the other amplifier being an optical pre-amplifier.

52. The method according to claim 47 wherein the optical fiber includes at least two spans of optical fiber, including at least one optical boost amplifier inserted between the at least two spans of optical fiber.

53. The method according to claim 47 wherein the optical fiber includes at least two spans of optical fiber, and including an optical dispersive element inserted between said at least two spans of optical fiber for reversing a sign of the temporal chirp applied to the optical pulses in each wavelength channel, and wherein said step of temporally de-chirping the temporally chirped multiplexed modulated optical signal pulses includes applying a de-chirp value having an appropriate magnitude and sign to substantially reconstruct the optical pulses.

54. The method according to claim 53 wherein the temporally chirped multiplexed modulated optical signal pulses are amplified by an optical boost amplifier inserted between the at least two spans of optical fiber.

55. The method according to claim 47 wherein the step of temporally chirping the modulated optical signal pulses includes varying, on a per wavelength channel basis, a sign of the temporal chirp applied to the modulated optical signal pulses in each of the at least two wavelength channels, wherein for a given wavelength channel, a sign of the temporal chirp applied thereto is chosen to be opposite to that of the de-chirp signal applied to the given wavelength channel.

56. The method according to claim 55 wherein alternating values of positive and negative chirp and de-chirp are applied to the wavelength channels, so that adjacent wavelength channels have opposite chirp and de-chirp signs when propagating through the optical transmission medium.

57. The method according to claim 47 wherein the step of temporally chirping the modulated optical signal pulses in each of the at least two wavelength channels includes temporally chirping the optical signal pulses in each of the at least two wavelength bands with a chirp having the same value for each wavelength channel, and wherein the step of temporally de-chirping the optical signal pulses includes applying a different chirp value to each wavelength channel to offset effects of chromatic dispersion of the optical transmission medium on each wavelength channel.

58. The method according to claim 47 wherein the step of temporally chirping the modulated optical signal pulses in each of the at least two wavelength channels includes applying a linear chirp of given slope to the modulated optical signal pulses in a given wavelength channel, and wherein the step of temporally de-chirping the temporally chirped modulated optical signal pulses in each of the at least two wavelength channels includes applying to the modulated optical signal pulses in the given wavelength channel a linear temporal chirp with a slope of opposite sign to the given slope.

59. The method according to claim 47 wherein forward error correction is used to further enhance the system performance.

60. The method according to claim 47 wherein the step of temporally chirping the modulated optical signal pulses for stretching the modulated optical signal pulses in each of said at least two wavelength channels includes
a) transmitting the modulated optical signal pulses in each wavelength channel through an optical branch device and then reflecting them using an optically chirped fiber Bragg grating with a chirp value chosen in such a way that the optical pulses are stretched by a selected amount, and
b) re-transmitting the stretched reflected multiplexed modulated optical signal pulses back through the optical branch device.

61. The method according to claim 47 wherein the step of temporally de-chirping the multiplexed modulated optical signal pulses for compressing the multiplexed modulated optical signal pulses back to their original pulse shapes in each of said at least two wavelength channels includes
a) transmitting the modulated optical signal pulses in each wavelength channel through an optical branch device and then reflecting them back through the optical branch device using an optically chirped fiber Bragg grating with a chirp value chosen in such a way that the optical pulses are compressed by a selected amount to give the original pulse shapes, and
b) re-transmitting the compressed reflected multiplexed modulated optical signal pulses back through an output of the optical branch device.

62. The method according to claim 47 wherein the step of temporally chirping the multiplexed modulated optical signal pulses for stretching the multiplexed modulated optical signal pulses in each wavelength channel includes transmitting the multiplexed modulated optical signal pulses in each wavelength channel through a section of an associated dispersive optical fiber having a chromatic dispersion value chosen in such a way that the multiplexed modulated optical signal pulses are stretched by the appropriate amount.

63. The method according to claim 47 wherein the step of temporally de-chirping the multiplexed modulated optical signal pulses for compressing the multiplexed modulated optical signal pulses to give the original pulse shapes includes transmitting the multiplexed modulated optical signal pulses through a section of an associated dispersive optical fiber having a chromatic dispersion value chosen in such a way that the multiplexed modulated optical signal pulses are compressed by the appropriate amount to give the original optical signal pulse shapes.

64. A method of suppressing four-wave mixing in a wavelength-division multiplexed optical communication network, comprising the steps of:
a) generating a set of odd wavelength channels and modulating optical signal pulses in each of the odd wavelength channels for encoding information onto the optical signal pulses in each of the odd wavelength channels;
b) generating set of even wavelength channels and modulating optical signal pulses in each of the even wavelength channels for encoding information onto the optical signal pulses in each of the even wavelength channels;
c) multiplexing the modulated optical signal pulses in the odd wavelength channels;
d) multiplexing the modulated optical signal pulses in the even wavelength channels;
e) temporally chirping the multiplexed modulated optical signal pulses in the odd wavelength channels;
f) temporally chirping the multiplexed modulated optical signal pulses in the even wavelength channels;
g) interleaving the temporally chirped multiplexed modulated optical signal pulses in each of the odd wavelength channels with the temporally chirped multiplexed modulated optical signal pulses in each of the even wavelength channels;
h) transmitting the interleaved, temporally chirped multiplexed modulated optical signal pulses in the odd and even wavelength channels through an optical fiber to a receiver;
i) de-interleaving the interleaved, temporally chirped multiplexed modulated optical signal pulses in the odd and even wavelength channels, temporally de-chirping the temporally chirped multiplexed modulated optical signal pulses in the odd wavelength channels thereby reconstructing the multiplexed modulated optical signal pulses in the set of odd wavelength channels, temporally de-chirping the temporally chirped multiplexed modulated optical signal pulses in the even set wavelength channels thereby reconstructing the multiplexed modulated optical signal pulses in the set of even wavelength channels;
j) demultiplexing the temporally de-chirped multiplexed modulated optical signal pulses in the set of odd wavelength channels thereby reconstructing the modulated optical signal pulses in each of the odd wavelength channels, demultiplexing the temporally de-chirped multiplexed modulated optical signal pulses in the set of even wavelength channels thereby reconstructing the modulated even wavelength optical signal pulses in each of the even wavelength channels;
g) detecting and converting the reconstructed modulated optical signal pulses in each of the odd and even set of wavelength channels respectively to associated modulated electrical signal pulses; and
h) filtering the modulated electrical signal pulses associated with each wavelength channel of the odd and even set of wavelength channels to remove out-of-band high frequency components due to four wave mixing of the multiplexed modulated optical signal pulses in the odd and even sets wavelength channels.

65. The method according to claim 64 wherein in steps e) and f) a chirp of selected value is applied to the multiplexed modulated optical signal pulses in each of the odd wavelength channels and a chirp of opposite sign but the same magnitude as the selected value is applied to the multiplexed modulated optical signal pulses in each of the even wavelength channels, and wherein in step j) the step of temporally de-chirping the temporally chirped multiplexed modulated optical signal pulses in the odd set of wavelength channels includes applying a de-chirp of opposite sign to the sign of the chirp value applied to the multiplexed modulated optical signal pulses in each of the odd set of wavelength channels, and wherein in step j) the step of temporally de-chirping the temporally chirped multiplexed modulated optical signal pulses in the even set of wavelength channels includes applying a de-chirp of opposite sign to the sign of the chirp value applied to the multiplexed modulated optical signal pulses in each of the even set wavelength channels.

66. The method according to claim 65 wherein the step of modulating the optical signal pulses in each of the odd and even set of wavelength channels includes producing modulated optical signals pulses in a return-to-zero (RZ) format.

67. The method according to claim 66 including amplifying the interleaved temporally chirped multiplexed modulated optical signal pulses.

68. The method according to claim 67 wherein the temporally chirped multiplexed modulated optical signal pulses are amplified using one or more erbium-doped fiber amplifier (EDFAs).

69. The method according to claim 67 wherein the temporally chirped multiplexed modulated optical signal pulses are amplified using one or more semiconductor optical amplifier (SOAs) or Raman amplifiers.

70. The method according to claim 67 wherein the temporally chirped multiplexed modulated optical signal pulses are amplified using two optical amplifiers, one of the two optical amplifiers being an optical boost amplifier and the other amplifier being an optical pre-amplifier.

71. The method according to claim 67 wherein the optical fiber includes at least two spans of optical fiber, including at least one optical boost amplifier inserted between the at least two spans of optical fiber.

72. A wavelength-division multiplexed optical communication network, comprising:
a) an optical signal transmitter including,
i) an optical signal source array having
a first array of optical signal sources for producing optical signal pulses in at least two odd wavelength channels, each of the optical signal sources in the first array of optical signal sources being optically coupled to an associated optical signal modulator for modulating the optical signal pulses that are output from the optical signal source coupled thereto to encode information onto the optical signal pulses in each of the odd wavelength channels;
a second array of optical signal sources for producing optical signal pulses in at least two even wavelength channels, each of the optical signal sources in the second array of optical signal sources being optically coupled to an associated optical signal modulator for modulating the optical signal pulses that are output from the optical signal source coupled thereto to encode information onto the optical signal pulses in each of the even wavelength channels;
ii) a first multiplexer, each optical signal modulator connected to the optical signal sources in the first array of optical signal sources having an output which is optically coupled to the first multiplexer for multiplexing the modulated optical signal pulses in the odd wavelength channels, a second multiplexer, each optical signal modulator connected to the optical signal sources in the second array of optical signal sources having an output which optically coupled to the second multiplexer for multiplexing the modulated optical signal pulses in the even wavelength channels;
iii) a first optical signal pulse stretcher being optically coupled to an output of the first multiplexer for temporally chirping the multiplexed modulated optical signal pulses in the odd wavelength channels, a second optical signal pulse stretcher being optically coupled to an output of the second multiplexer for temporally chirping the multiplexed modulated optical signal pulses in the even wavelength channels, the second optical signal pulse stretcher applying a temporal chirp to the multiplexed modulated optical signal pulses in the even wavelength channels which is of opposite sign to a temporal chirp applied to the multiplexed modulated optical signal pulses in the odd wavelength channels by the first optical signal pulse stretcher;
iv) an optical signal pulse interleaver optically coupled to an output of each of the first and second multiplexors for interleaving the temporally chirped multiplexed modulated optical signal pulses in the odd wavelength channels with the temporally chirped multiplexed modulated optical signal pulses in the odd wavelength channels;
v) an optical fiber having opposed ends being optically coupled at one of the opposed ends to an output of the interleaver through which the interleaved, temporally chirped multiplexed modulated optical signal pulses from the odd and even wavelength channels are transmitted; and
b) an optical signal receiver for receiving the interleaved temporally chirped multiplexed modulated optical signal pulses from the odd and even wavelength channels, the optical signal receiver including,
i) an optical signal pulse de-interleaver being optically coupled to the other of the opposed ends of the optical fiber for de-interleaving the interleaved, temporally chirped multiplexed modulated optical signal pulses from the odd and even wavelength channels,
ii) a first optical signal pulse compressor being optically coupled to a first output of the de-interleaver for temporally de-chirping the multiplexed modulated optical signal pulses in the odd wavelength channels with a temporal chirp of opposite sign to the temporal chirp applied by the first optical signal pulse stretcher for reconstructing the multiplexed modulated optical signal pulses in the odd wavelength channels, a second optical signal pulse compressor being optically coupled to a second output of the de-interleaver for temporally de-chirping the multiplexed modulated optical signal pulses in the even wavelength channels with a temporal chirp of opposite sign to the temporal chirp applied by the second optical signal pulse stretcher for reconstructing the multiplexed modulated optical signal pulses in the even wavelength channels;
iii) a first demultiplexer having an input optically coupled to an output of the first optical signal pulse compressor for demultiplexing the reconstructed multiplexed modulated optical signal pulses in the odd wavelength channels to reconstruct the modulated optical signal pulses in each of the odd wavelength channels, a second demultiplexer having an input optically coupled to an output of the second optical signal pulse compressor for demultiplexing the reconstructed multiplexed modulated optical signal pulses in the even wavelength channels to reconstruct the modulated optical signal pulses in each of the even wavelength channels,
iv) a first array of first optical detectors, each of the first optical detectors being connected to an associated output of the first demultiplexer for converting the reconstructed modulated optical signal pulses in the odd wavelength channels to modulated electrical signal pulses, each of the first optical detectors having an associated filter electrically connected thereto for filtering the modulated electrical signal pulses produced therein with each filter having a predefined filter bandwidth for removing out-of-band frequency components due to four wave mixing arising from multiplexing the modulated optical signal pulses in the odd wavelength channels, a second array of second optical detectors, each of the second optical detectors being connected to an associated output of the second demultiplexer for converting the reconstructed modulated optical signal pulses in the even wavelength channels to modulated electrical signal pulses, each of the second optical detectors having an associated filter electrically connected thereto for filtering the modulated electrical signal pulses produced therein with each filter having a predefined filter bandwidth for removing out-of-band frequency components due to four wave mixing arising from multiplexing the modulated optical signal pulses in the even wavelength channels.

73. The optical communication network according to claim 72 wherein the optical signal modulators produce modulated optical signals pulses in a return-to-zero (RZ) format.

74. The optical communication network according to claim 73 including at least one optical amplifier inserted between optical signal pulse interleaver and the optical signal pulse de-interleaver for amplifying the temporally-chirped multiplexed modulated optical signal pulses.

75. The optical communication network according to claim 74 wherein the at least one optical amplifier is two optical amplifiers, an optical boost amplifier being inserted between the optical signal pulse interleaver and the optical fiber, and wherein an optical pre-amplifier is inserted between the optical fiber and the optical signal pulse de-interleaver.

76. The optical communication network according to claim 75 wherein the two amplifiers are erbium-doped fiber amplifiers (EDFAs).

77. The optical communication network according to claim 75 wherein the two amplifiers are semiconductor optical amplifiers (SOAs) or Raman amplifiers.

78. The optical communication network according to claim 73 wherein the optical fiber includes at least two spans of optical fiber, including at least one optical boost amplifier inserted between the at least two spans of optical fiber.

79. The optical communication network according to claim 73 wherein each optical signal pulse stretcher includes a chirped fiber Bragg grating optically coupled to an optical branch device, and wherein a chirp of the chirped fiber Bragg grating is chosen in such a way that the optical pulses in each of the even and odd wavelength channels are stretched by a desired amount, and wherein each optical signal pulse compressor includes a chirped fiber Bragg grating optically coupled to an associated optical branch device, and wherein a chirp of the chirped fiber Bragg grating is chosen in such a way that the optical pulses in each of the even and odd wavelength channels are compressed by a desired amount.

80. The optical communication network according to claim 73 wherein each optical signal pulse stretcher includes a segment of dispersive optical fiber having a chromatic dispersion value chosen in such a way that the optical pulses in the even and odd wavelength channels are stretched by an appropriate amount, and wherein each optical signal pulse compressor includes a segment of dispersive optical fiber having a chromatic dispersion value chosen in such a way that the optical pulses in each of the even and odd wavelength channels are compressed by an appropriate amount.

81. The optical communication network according to claim 73 including processing means connected to the optical communication network for performing forward error correction to further enhance the system performance.
